(19) United States
(12) Patent Application Publication
(10) Pub. No.: US 2013/0011326 A1
(43) Pub. Date: Jan. 10, 2013

(54) Process For The Production Of Hydrogen And Carbon Dioxide Utilizing Magnesium Based Sorbents

(75) Inventor: Bhadra S. Grover, Sugar Land, TX (US)

(73) Assignee: L' Air Liquide Societe Anonyme Pour L'Etude Et L'Exploitation Des Procedes Georges Claude, Paris (FR)

(21) Appl. No.: 13/176,602

(22) Filed: Jul. 5, 2011

(51) Int. Cl. C01B 31/20

(52) U.S. Cl. 423/437.1

(57) ABSTRACT

The present invention relates to a process for recovering hydrogen along with high temperature high pressure carbon dioxide from one or more hydrocarbon gas streams by incorporating a carbon dioxide recovery unit which utilizes a fluidized magnesium based sorbent into a process that includes a gasification unit, an optional sulfur removal unit, a water gas shift reactor and a hydrogen pressure swing adsorption unit.

### FIELD OF THE INVENTION

The present invention relates to an energy efficient process for recovering hydrogen along with high temperature, high pressure carbon dioxide utilizing a high pressure syngas gasification unit, an optional sulfur removal unit, a water gas shift reactor, one or more sorbent beds containing a magnesium based sorbent, and a pressure swing adsorption unit.

### BACKGROUND

A number of different products have been proposed for use in prior art methods for the removal of carbon dioxide. However, most of the products used have to be regenerated at low pressure thereby resulting in the production of a carbon dioxide stream that is at low pressure. For example, U.S. Pat. No. 6,322,612 describes a pressure swing adsorption process for carbon dioxide removal. However, carbon dioxide is produced at low atmospheric or sub-atmospheric pressure. Solvent scrubbing processes such as the amine scrubbing process requires gas cooling below 40° C. thereby resulting in a loss of thermal efficiency. Sorbents such as zeolites have their capacities lowered at temperatures above about 200° C., and are strongly affected by the presence of moisture. In addition, sorbents such as calcium based sorbents and lithium based sorbents have been shown to adsorb carbon dioxide within the 200° C. to 400° C. temperature range but must be regenerated at low pressure and much higher temperatures (from 700° C. or greater) thereby requiring a large amount of regeneration energy.

New sorbents have been proposed for the removal of carbon dioxide. The publication “Novel Regenerable Magnesium Hydroxide Sorbent for CO₂ Capture at Warm Gas Temperatures” by Rajani V Siriwardane and R. W Stevens of NETL describes a sorbent based on Mg(OH)₂ that can capture carbon dioxide at temperatures from 200° C. to 315° C. and can regenerate carbon dioxide at 20 bar and from 375° C. to 400° C. The noted article indicates that this sorbent may be used in applications such as coal gasification systems. U.S. Pat. No. 7,314,847 sets forth a process for preparing this sorbent. These sorbents produce CO₂ streams at elevated pressure and temperature, however the CO₂ stream needs further treatment to remove contaminants.

Accordingly, while there are a variety of different sorbents and different processes for removing carbon dioxide, there still exists a need to provide for a process that allows for the economical recovery of hydrogen as well as carbon dioxide where it is possible to remove the carbon dioxide at high pressure and high temperature.

### SUMMARY OF THE INVENTION

The present invention relates to a process for recovering hydrogen along with high temperature high pressure carbon dioxide from one or more hydrocarbon feed streams by incorporating a carbon dioxide recovery unit which utilizes a magnesium based sorbent in a fluidized form into a process that includes a gasification unit, an optional sulfur removal unit, a water gas shift reactor and a pressure swing adsorption unit. By incorporating such a carbon dioxide recovery unit into such a process, it makes it possible to provide a more economical recovery of carbon dioxide, thereby improving the overall economics of hydrogen and carbon dioxide production.

### BRIEF DESCRIPTION OF THE FIGURES

FIG. 1 provides a schematic of the process of the present invention.

### DETAILED DESCRIPTION OF THE INVENTION

The process of the present invention provides for the incorporation of a sorbent based carbon dioxide removal unit into a process for the production of high purity hydrogen and high temperature, high pressure carbon dioxide. By utilizing a solid sorbent based carbon dioxide removal unit in which the sorbent is transported and cycled to different beds for sorption and desorption of carbon dioxide, it is possible to effectively remove the carbon dioxide present from the water gas shift effluent produced in the gasification unit/sulfur removal unit/water gas shift reactor thereby producing a concentrated carbon dioxide product at high temperature and pressure while still efficiently recovering the hydrogen product at high purity. As used herein, the phrase “high pressure and high temperature” with regard to the resulting carbon dioxide stream refers to a carbon dioxide stream at a pressure from about 10 bar to about 30 bar and a temperature from about 375° C. to about 420° C. The sorbent in the bed is kept fluidized or moving to be able to transport it from one bed to another bed. Note that when the purity of the carbon dioxide product is not of a greater concern (where the desire is to have a carbon dioxide product with a purity that is greater than 95%) it is not necessary to include the purge phase as in the second embodiment.

The process of the present invention involves recovering high purity hydrogen and high purity carbon dioxide from one or more hydrocarbon feed streams utilizing a gasification unit, in combination with an optional sulfur removal unit, a water gas shift reactor and a pressure swing adsorption unit along with a carbon dioxide removal unit comprising one or more sorbent beds in which a magnesium based sorbent is transported and cycled between different beds for sorption and desorption of carbon dioxide. By incorporating this sorbent based carbon dioxide removal unit between the water gas shift reactor and the hydrogen pressure swing adsorption unit, it is possible to effectively remove the carbon dioxide present in the water gas shift effluent to produce a concentrated carbon dioxide product that is produced at high pressure/high temperature. In addition to producing a concentrated carbon dioxide product, during the purge of the sorbent beds, the sorbent beds are purged with high pressure steam to remove the hydrogen, carbon monoxide and methane trapped in the void spaces of the sorbent (hereinafter “purge stream”) to be recycled as a supplemental feed for the water gas shift reactor. The amount of steam used for purging the bed correspondingly reduces the amount of steam added to the water gas shift reactor. This presents the further advantage of no net steam utilized for purging. The recycle of hydrogen, carbon monoxide and methane at high temperature improves the overall efficiency of the hydrogen production. The purge phase of the carbon dioxide removal step improves the purity of the carbon dioxide stream, which is important if part of the carbon dioxide stream is used elsewhere as a product. Note that the pressure of the purge stream is raised via a thermo-compressor to be able to recycle it to the water gas shift reactor.

Following the purge phase, the sorbent bed is heated to desorb the pure carbon dioxide at the desired pressure. The resulting carbon dioxide depleted stream obtained as a part of these process steps is passed along to a pressure swing adsorption unit for producing a high purity stream of hydrogen. These process steps in turn maximize the use of energy contained in streams produced during the sorption phase of the carbon dioxide removal step while minimizing the additional treatment often necessary for use of the various streams produced according to conventional processes.

The process of the present invention involves recovering high purity hydrogen and high purity carbon dioxide from one or more hydrocarbon feed streams utilizing a high pressure gasification unit in combination with an optional sulfur removal unit, a water gas shift reactor, a carbon dioxide removal unit comprising one or more sorbent beds and a pressure swing adsorption unit. As used herein, the phrase “high purity carbon dioxide” refers to a carbon dioxide stream that contains greater than 90% carbon dioxide, preferably greater than 95% carbon dioxide and even more preferably, greater than 99% carbon dioxide. Furthermore, as used herein, the phrase “high purity hydrogen” refers to a hydrogen stream that contains greater than 90% hydrogen, preferably greater than 95% hydrogen and even more preferably, greater than 99% hydrogen.

More specifically, the process involves introducing one or more hydrocarbon feed streams into a gasification unit to generate a syngas stream, optionally treating the syngas stream in a sulfur removal unit (when the syngas stream is a sour syngas stream) to produce an essentially sulfur free syngas, treating syngas stream in a water gas shift reactor to obtain a water gas shift effluent, subjecting the water gas shift effluent to treatment in a carbon dioxide removal unit containing one or more sorbents beds to produce a carbon dioxide depleted stream, an optional purge effluent gas and a carbon dioxide rich stream, introducing the carbon dioxide depleted stream into a hydrogen pressure swing adsorption unit to allow for the recovery of hydrogen, recycling the purge effluent gas to be recycled to the water gas shift reactor, and withdrawing all or part of the carbon dioxide as product.

Those of ordinary skill in the art will recognize that the carbon dioxide depleted stream and the purge effluent gas may also contain residual amounts of carbon dioxide as well as the other components that may be present in the original gas stream treated. As used herein, the phrase “residual amounts” when referring to the amounts of other components that may be present in the carbon dioxide depleted stream refers collectively to an amount that is less than about 5.0%, preferably less than about 3.0% and even more preferably less than about 1.0%.

The present process provides for two main embodiments: one embodiment that contains four phases, including a purge phase, and another embodiment that contains three phases, since no purge phase is necessary. Within each of these embodiments, there are two subembodiments: one that includes a sulfur removal unit when the syngas is a sour syngas and another that does not include a sulfur removal unit when the syngas is a sweet syngas. As noted hereinbefore, the inclusion of the purge phase is in those instances where it is important to have a carbon dioxide purity that is equal to or greater than 95%. While both embodiments will be discussed herein, the main discussion will center on the embodiment where purity greater than 95% is desired. Note that in the embodiment where a purge phase is included, the sorbent is purged with steam to remove any entrained gases such as hydrogen, carbon monoxide, and methane that are carried over with the sorbent from the first sorbent bed. This increases the purity of carbon dioxide being recovered in the next step.

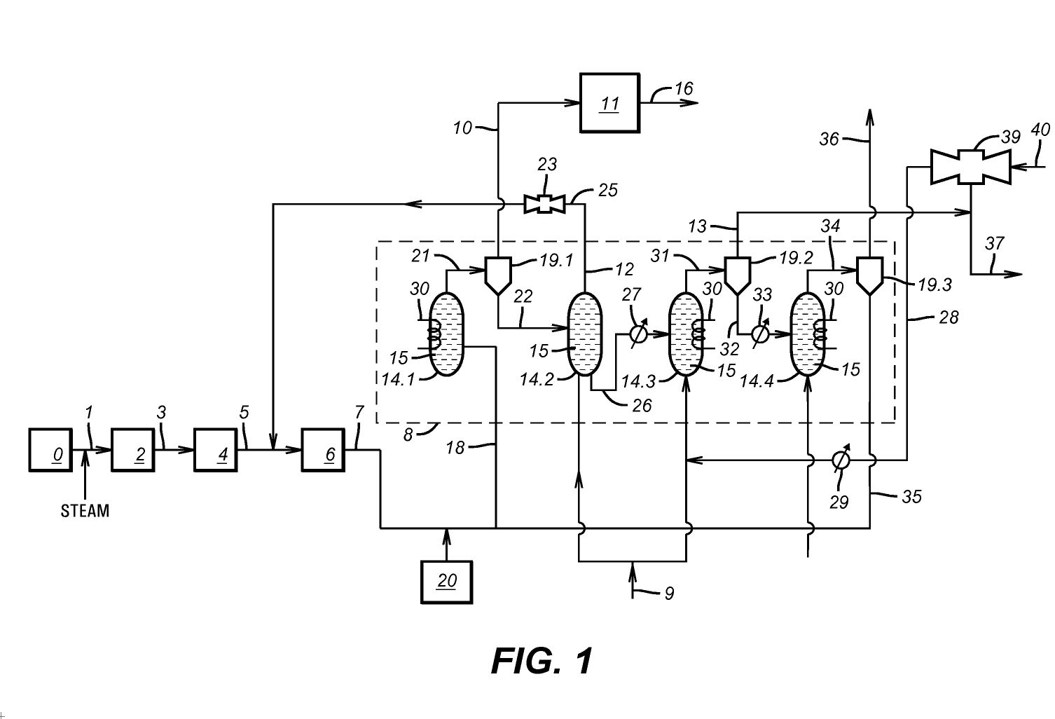

The process will be further described in more detail with reference to the single FIGURE contained therein (FIG. 1). Note that this FIGURE is not meant to be limiting with regard to the present process and is included simply for non-limiting illustrative purposes. The first step of the present process, as shown in FIG. 1, involves generating a syngas stream by treating one or more hydrocarbon feed streams in a gasification unit 2, the one or more hydrocarbon feed streams being obtained from a source 0 via line 1. The high pressure gasification unit contemplated for use in the present invention is any gasification unit 2 known in the art which is capable of processing hydrocarbon feed streams in order to produce a syngas stream that also contains at least hydrogen and carbon dioxide. Furthermore, as used herein, the phrases “hydrocarbon feed”, “hydrocarbon feeds”. “hydrocarbon feed stream” or “hydrocarbon feed streams” refer to any solid or liquid fuel or solid or liquid fuel source which is derived from organic materials such as refinery residue materials (for example, tar, heavy oils, petcoke, coke) or coal or biofuels (for example, wood, peat, corn, corn husks, wheat, rye and other grains), crude oil, coal or natural gas. In the preferred embodiments of the present invention, the hydrocarbon feed streams 0 are preferably selected from refinery residues, coal and biofuels. Gasification units 2 such as those proposed for the present process are readily known to those skilled in the art. Accordingly, the present process is not meant to be limited to a specific gasification unit 2 or the process for carrying out the reaction in the gasification unit 2.

With regard to the gasification units 2, the desire is to produce a syngas stream that is rich in hydrogen, carbon monoxide, and carbon dioxide as these are the ultimate products. However, depending upon the original hydrocarbon fuel source utilized, the final syngas stream produced in the gasification units 2 may include a variety of other components such as, but not limited to, sulfur containing compounds and nitrogen containing compounds that are produced in the gasification unit 2. Syngas streams that contain such compounds are typically referred to as sour syngas streams. When the syngas stream is a sour syngas stream, is desirable to remove at least the sulfur containing compounds from the sour syngas stream upstream of the carbon dioxide removal unit 8 as the sulfur compounds can cause problems with the magnesium based sorbent. Note that there is a sour water gas shift that works with sulfur containing sour gas. However, the operating conditions for the sour water gas shift can be different from the sweet (no sulfur) water gas shift. Those skilled in the art can make an economic choice of using sour water gas shift or sweet water gas shift. Accordingly, depending upon the choice, the sulfur removal unit can be upstream or downstream of the water gas shift. For purposes of the present invention, the discussion focuses on the sweet water gas shift reactor (where the sulfur is removed before the stream is introduced into the water gas shift reactor). Note for treatment of syngas streams that are produced without the presence of sulfur containing compounds, the sulfur removal unit is not necessary.

For purposes of the present discussion, it is assumed that the syngas stream will contain sulfur containing compounds. Accordingly, in the next step of the process, the sulfur containing compounds in the syngas stream are removed prior to the syngas stream being injected into the water gas shift reactor 6 by introducing the syngas stream into a sulfur removal unit 4.

Depending upon the sulfur removal process utilized, the syngas exiting the gasification unit 2 may need to be cooled before it can be further processed. Those skilled in the art recognize that there are various ways that the syngas can be cooled or quenched. The present invention is not meant to be limited by this means of cooling/quenching. Accordingly, the cooling of the syngas is not shown in the FIG. 1. However, it is desirable to remove the sulfur containing compounds at high temperature of from about 250° C. to about 400° C., as compared to conventional amine processes that operate at lower temperatures of from about 30° C. to about 70° C., to avoid cooling the syngas for sulfur removal and reheating it for the water gas shift reaction as such cooling and reheating results in the need for extra steps, extra energy and extra costs. One process for removing sulfur containing compounds from sour syngas is described in NETL Project Facts “Integrated Warm Gas Multicontaminant Cleanup Technologies for Coal-Derived Syngas”. Accordingly, such a process or a similar process allowing for the removal of sulfur containing compounds without the need to cool the sour syngas is preferred. Note the present process is not meant to be limited to a sulfur removal unit 4 or the process for carrying out the reaction in the sulfur removal unit 4. As a result of the removal of the sulfur, an essentially sulfur free syngas stream is produced. As used herein, the phrase “essentially sulfur free” when used in terms of the syngas stream refers to a syngas stream that comprises less than 10 ppm of sulfur containing compounds, preferably less than 1 ppm sulfur containing compounds.

After the sulfur is removed from the syngas to produce an essentially sulfur free syngas stream, this essentially sulfur free syngas stream is treated in a water gas shift reactor 6 to further enrich the hydrogen content of the essentially sulfur free syngas stream and to also increase the carbon dioxide content in the essentially sulfur free syngas stream by oxidizing a portion of the carbon monoxide present in the essentially sulfur free syngas stream to carbon dioxide thereby obtaining a water gas shift effluent. In this embodiment, the essentially sulfur free syngas stream is introduced via line 5 into the water gas shift reactor 6 (which can contain a variety of stages or one stage; stages not shown) to form additional hydrogen and carbon dioxide. Note that additional steam may also be added (not shown) upstream of the water gas shift reactor 6 along line 5. The result is a water gas shift effluent that is also at high temperature and high pressure. The conditions under which water gas shift reaction is carried out are well known to those skilled in the art. Accordingly, the present process is not meant to be limited to a specific water gas shift reactor 6 or the process for carrying out the reaction in the water gas shift reactor 6. Accordingly, any water gas shift reactor 6 known in the art may be used in the process of the present invention.

In the next step of the present process, the water gas shift effluent that is obtained from the water gas shift reactor 6 is subjected to treatment in a carbon dioxide removal unit 8 that contains at least four sorbent beds 14 (individually labeled as 14.1, 14.2, 14.3, and 14.4), that are configured to allow for the use of a magnesium based sorbent 15 in a loose form with each of the sorbent beds 14 corresponding to a different phase in the first embodiment of the present process for the removal of the carbon dioxide from the stream utilizing the loose sorbent.

The sorbent 15 that is utilized in the process of the present invention is highly selective for carbon dioxide and is selected from magnesium based sorbents, more particularly magnesium hydroxide sorbents. The sorbent 15 in this fluidized/moving bed process is typically found in the form of small beads, granules, or crumbs of the sorbent 15 that are small enough in size to allow for these forms to be easily fluidized. Of these sorbents 15, the most preferred with regard to the present process are the magnesium hydroxide sorbent such as those disclosed in U.S. Pat. No. 7,314,847 and Novel Regenerable Magnesium Hydroxide Sorbent for CO₂ Capture, the full contents of each incorporated herein.

The magnesium based sorbent utilized in the process of the present invention is in a moving/fluidized form. Those skilled in the art of moving/fluidized beds will recognize that fluidization requires the gas stream to lift and move the solids, and special separators to separate the gas from the solids. Similarly, moving beds require moving grates, conveyors, etc. Such various manners of fluidization are well known to those skilled in the art therefore details are not included herein. The ability to move the sorbent 15 around makes it a continuous and steady state process, as compared to a batch process for fixed beds.

Those skilled in the art will recognize that the present process may be carried out using any number of sorbent beds 14 provided that at least one bed 14 corresponds to each phase of the process and that flow between such beds 14 can be controlled by any means known in the art such as through strategically placed lines and valves. In one preferred embodiment of the present process as set forth in FIG. 1, the schematic configuration utilized with regard to the carbon dioxide removal unit 8 is a configuration that contains at least four sorbent beds 14 with at least one sorbent bed 14 utilized in each phase of the process.

The sorbent 15 passes through the series of sorbent beds 14 which correspond to the various phases of carbon dioxide removal within the carbon dioxide removal system: the sorption phase (sorbent bed 14.1), the purge phase (sorbent bed 14.2), the carbon dioxide release phase (sorbent bed 14.3) and the rehydroxylation phase (sorbent bed 14.4). With regard to the example set forth in FIG. 1, the water gas shift effluent from line 7 is typically injected into the first sorbent bed 14.1 along with a supply of sorbent 15 via line 18. Note the method of conveying sorbent by gas is well known to those familiar with the art, and is not discussed or shown herein. Similarly, separation of gas from sorbent, shown as 19.1, 19.2, and 19.3 in FIG. 1 is well known to those familiar with the art.

As noted, the treatment of the water gas shift effluent in the sorbent beds 14 involves four phases: a sorption phase, a purge phase, a carbon dioxide release phrase and a sorbent rehydroxylation phase. The first of these phases, the sorption phase, involves introducing the water gas shift effluent via line 7 into the first sorbent bed 14.1 in the carbon dioxide removal unit 8 along with the magnesium based sorbent 15 obtained from the sorbent source 20 or recycled from 14.4 (discussed further herein). As the sorbent 15/water gas shift effluent pass through the first sorbent bed 14.1, the carbon dioxide in the syngas stream selectively reacts with the sorbent 15 resulting in the production of a mixture comprising reacted sorbent and a carbon dioxide deficient stream. As the carbon dioxide deficient stream and reacted sorbent 15 pass through the fluidized sorbent bed 14.1, the components of the water gas shift effluent (mainly carbon dioxide) that react with the sorbent 15 are retained on (affixed to) the sorbent 15.

Note that the residence time of sorbent in the first sorbent bed 14.1 will depend upon the particular sorbent 15 utilized. As used herein, with regard to the sorption phase, the term “capacity” and phrase “high capacity” each refer to the amount of carbon dioxide that the sorbent 15 will remove from the water gas shift effluent. More specifically, the term “capacity” and phrase “high capacity” each refer to the amount of reactive sites (hydroxyl sites) of the sorbent 15 that react with carbon dioxide.

The balance of the unreacted water gas shift effluent (the carbon dioxide depleted stream) along with reacted sorbent 15 exits the sorbent bed 14.1 via line 21 and is then passed to a phase separator 19.1 where carbon dioxide depleted stream is separated from the reacted sorbent 15. The carbon dioxide depleted stream comprises both hydrogen and carbon monoxide in high concentrations and is essentially carbon dioxide free. As used herein, the phrase “essentially carbon dioxide free” refers to a stream that contains less than about 1.0% carbon dioxide, preferably less than about 0.5% carbon dioxide and even more preferably, less than about 0.1% carbon dioxide. However, as noted before, those skilled in the art will recognize that these essentially carbon dioxide free streams often contain residual amounts of other components that may be present in the original water gas shift effluent to be treated as well.

Note that the temperature at which the water gas shift effluent is introduced into the sorbent bed 14.1 will depend upon the specific sorbent 15 utilized as well as the conditions under which the reforming reaction is carried out. Typically, the water gas shift effluent will be introduced into the first sorbent bed 14.1 at a temperature that ranges from about 100° C. to about 315° C. and at a pressure that ranges from about 10 bar to about 60 bar, preferably at a temperature that ranges from about 180° C. to about 300° C. and at a pressure from about 20 bar to about 40 bar.

With regard to the actual chemical reaction taking place with regard to the sorbent 15, the sorbent 15 reacts with the carbon dioxide in the water gas shift effluent to produce a carbonate and water. For example, in the case of magnesium hydroxide the reaction is:

Mg(OH)₂+CO₂→MgCO₃+H₂O

The magnesium hydroxide reacts with the carbon dioxide to yield magnesium carbonate and water. While a majority of the carbon dioxide present in the water gas shift effluent will react with the magnesium hydroxide sorbent 15 to form a carbonate, a small amount of the carbon dioxide will remain unreacted. Generally greater than 90% of the carbon dioxide in the water gas shift effluent will be removed from the water gas shift effluent by the sorbent 15, preferably greater than 95% and even more preferably greater than 99%.

As noted above, the phase separator 19.1 separates the sorbent from the remaining components of the water gas shift effluent. As used herein with regard to the sorption phase, the phrase “remaining components” refers to the hydrogen, carbon monoxide, methane, water vapor and other components as defined hereinbefore (also referred to as the carbon dioxide depleted stream). In addition, the carbon dioxide depleted stream may also include a small amount of the carbon dioxide that does not react with the sorbent 15. The carbon dioxide depleted stream is sent via line 10 to the hydrogen pressure swing adsorption unit 11 for further treatment to produce a purified hydrogen stream.

The next phase in the carbon dioxide removal unit 8 is the purging of the sorbent 15 in order to remove those nonspecifically entrained components. The sorbent 15 that results from separator 19.1 is introduced into a second sorbent bed 14.2 from line 22 along with high pressure superheated steam from line 9. As a result, the reacted sorbent 15 is purged of the nonspecifically trapped components from the water gas shift effluent thereby producing a purge effluent gas. As noted previously, it is desirable to include the purge phase of the process only when a very high purity carbon dioxide product is desired. The amount of steam required for the purge may not be adequate to fluidize the sorbent 15 in bed 14.2 and therefore it may be preferential to use a moving bed to remove the sorbent 15 from the bottom of the bed 14.2.

During the purge phase of the process, the superheated steam injected into the second sorbent bed 14.2 serves to displace a large portion of the remaining components that are nonspecifically trapped in the sorbent 15, thereby producing a purge effluent gas (also referred to as a purge stream) which contains these dislodged components. This purge effluent gas is withdrawn from the second sorbent bed 14.2 via line 12 for example through a reversible flow conduit (not shown) and passed on to a thermo-compressor 23. The purge effluent gas is then recycled via line 24 along with the superheated steam injected via line 25 into the thermo-compressor 23 to the line 5 feeding into the water gas shift reactor 6. Accordingly, the steam in hot purge effluent gas is utilized in the shift step. This purge effluent gas which contains hydrogen, carbon monoxide water vapor and methane is used as a supplemental feed to maximize production of hydrogen and carbon dioxide. Note that once the purge effluent gas is separated from the purged sorbent 15, the purged sorbent 15 is then passed to the third sorbent bed 14.3 via line 26 for the next phase of treatment in the carbon dioxide removal unit 8—the carbon dioxide release phase.

In the third phase of treatment, the carbon dioxide is released from the sorbent 15 in the third sorbent bed 14.3 producing a high purity carbon dioxide stream that is also at high pressure and high temperature. This is accomplished by increasing the temperature of the purged sorbent 15 in a first heat exchanger 27 and within the third sorbent bed 14.3. A portion of the carbon dioxide recycle stream via line 28 can be added along with steam via line 9 to provide additional gas flow required for fluidization of the sorbent bed 14.3. The increase in temperature of the third sorbent bed 14.3 may be achieved in three ways or combinations thereof. The temperature of the superheated steam stream provided via line 9 can be increased, the temperature of the recycle carbon dioxide provided via line 28 can be increased through the use of a third heat exchanger 29, and/or by additional heating means such as an indirect heat exchanger 30 may be used to increase the temperature of the purged sorbent 15 in the third sorbent bed 14.3 from about 180° C. to about 315° C. to from about 350° C. to about 420° C. In each of these cases, the increase in temperature is to allow for the release of carbon dioxide from the sorbent 15 thereby producing a carbon dioxide stream that is not only hot but also wet.

The mixture of sorbent 15 and the carbon dioxide gas steam is then passed along via line 31 to a second phase separator 19.2 where the carbon dioxide gas is separated from the sorbent 15. The carbon dioxide gas stream is then routed for use as product via line 13 and line 37 or recycled back to the sorbent bed 14.3 via line 29. The sorbent 15 is passed along line 34 to a final and fourth sorbent bed 14.4 for the rehydroxylation of the sorbent 15 to take place. More specifically, with regard to the sorbent 15, the carbon dioxide is released from the carbonate formed in the sorption phase and MgO is formed which is sent to the fourth sorbent bed 14.4 for rehydroxylation to take place. In line with the previous example, this is demonstrated by the reactions as follows:

MgCO₃→MgO+CO₂

MgO+H₂O→Mg(OH)₂

As shown in this example, during the release portion of this phase, the magnesium carbonate is subjected to the noted temperatures (from about 350° C. to about 420° C.) to yield magnesium oxide and carbon dioxide.

Within the fourth sorbent bed 14.4, the sorbent is subjected to a reduced temperature to allow for the rehydroxylation. More specifically, the temperature is from about 200° C. to about 300° C. in order to allow for the rehydroxylation of the sorbent 15. During rehydroxylation, the sorbent 15 in the sorbent bed 14.4 is being contacted with the steam and/or any other moisture containing stream supplied via line 41. The sorbent may be cooled indirectly in a heat exchanger 33 upstream of sorbent bed 14.4.

During the rehydroxylation portion of this phase, magnesium oxide reacts (via hydroxylation) with water present in the steam or other moisture containing stream to yield magnesium hydroxide (a regenerated sorbent). The mixture of steam and/or any other moisture containing stream and the rehydroxylated sorbent 15 is withdrawn from the fourth sorbent bed 14.4 via line 34 and passed to the third phase separator 19.3 where they are separated and the rehydroxylated sorbent 15 is recycled via line 35 to line 18 where it can be reutilized to treat the water gas shift effluent being injected into the first sorbent bed 14.1. The remaining steam and/or other moisture containing stream is withdrawn via line 36 and either condensed or used elsewhere.

The carbon dioxide stream produced can be utilized in two manners. First, as noted above, all or a portion of the carbon dioxide stream can be recycled via line 28 to be used as a supplemental gas for fluidization of sorbent in sorbent bed 14.3. Note that prior to the carbon dioxide stream being recycled to the sorbent bed 14.3, the pressure of carbon dioxide may need to be raised by a thermo-compressor 39 which is supplied with additional high pressure steam via line 40. The thermo-compressor 39 uses from 20 to 60 bar high pressure steam as motive force. The motive steam supplied via line 40 provides mechanical energy to increase pressure of the carbon dioxide stream and heat for carbon dioxide release. Those skilled in the art will recognize the limitations of the thermo-compressors 39 in terms of available pressure rise.

The remaining portion of the carbon dioxide stream can be utilized as carbon dioxide product as this stream is of high purity. This carbon dioxide product stream can be withdrawn for further use via line 37.

As noted above, the carbon dioxide depleted gas stream obtained in the first phase (the sorption phase) may be withdrawn and used as product or routed for further treated in the hydrogen pressure swing adsorption unit 11. Any hydrogen pressure swing adsorption unit 11 know in the art may be utilized for the purification of the hydrogen. Accordingly, the present invention is not meant to be limited by the hydrogen pressure swing adsorption unit 11 utilized. As a result of the further treatment of the carbon dioxide depleted gas stream, it is possible to produce a high purity hydrogen stream.

A still further embodiment of the present invention involves modifying the carbon dioxide removal unit 8 to allow for the recovery of the heat of sorption and the heat of rehydroxylation in the sorbent beds 14.1 and 14.4 and to supply heat in sorbent bed 14.3 for the release of carbon dioxide. The hot heat transfer media can be utilized to transfer heat within the carbon dioxide removal unit 8 or exchange heat between the carbon dioxide removal unit and the gasification unit 2 or in the water gas shift reactor 6. The heat transfer media can also be used to generate high pressure steam to be utilized in the carbon dioxide removal unit 8, or gasification unit 2 or water gas shift reactor 6. The modified carbon dioxide removal unit 8 would therefore comprise at least four sorbent beds 14.1, 14.2, 14.3 and 14.4 containing sorbent 15 and a series of heat transfer surfaces 30 that run through at least beds 14.1 (the sorption phase), 14.3 (the carbon dioxide release phase), and 14.4 (the rehydroxylation phase). The heat transfer surfaces 30 would each have a media running there through to adsorb the heat of sorption or the heat of rehydroxylation, and provide heat for carbon dioxide release. More specifically, the heated transfer media would be used to exchange heat between the carbon dioxide removal unit 8 and various process streams of the gasification unit 2 and the water gas shift reactor 6, or generate high pressure steam for the carbon dioxide removal unit 8. A variety of different types of heat transfer media are available to be utilized in this manner. Examples of such heat transfer media include, but are not limited to, a molten carbonate salt mixture or any inorganic or organic compound with a boiling point that ranges from about 250° C. to about 350° C.

The second embodiment of the present process is similar in nature to the first embodiment as shown in FIG. 1 with the exception that this embodiment only contains three phases (embodiment not shown), since no purge phase is necessary. Accordingly, only a carbon dioxide depleted stream and a high temperature/high pressure carbon dioxide rich stream are produced. With regard to this particular embodiment, as the sorbent 15 is not purged, there will likely be residual components in the carbon dioxide product stream as these residual components are not removed prior to the release of the carbon dioxide from the reacted sorbent 15.

### ELEMENTS OF THE FIGURES

0—hydrocarbon feed stream source
1—line that provides hydrocarbon feed steams to high pressure gasification unit
2—high pressure gasification unit
3—line that provides syngas stream from the high pressure gasification unit to the sulfur removal unit
4—sulfur removal unit
5—line that provides essentially sulfur free syngas to the water gas shift reactor
6—water gas shift reactor
7—line that introduces water gas shift effluent into the carbon dioxide removal unit
8—carbon dioxide removal unit
9—line through which the high pressure superheated steam is introduced into the carbon dioxide removal unit
10—line through which the carbon dioxide depleted stream is introduced into the hydrogen pressure swing adsorption unit
11—hydrogen pressure swing adsorption unit
12—line by which the purge effluent gas is withdrawn from the carbon dioxide removal unit and recycled to the line that provides the syngas stream to the water gas shift reactor
13—line by which the high temperature/high pressure carbon dioxide purified stream is withdrawn
14—sorbent bed
14.1—first sorbent bed
14.2—second sorbent bed
14.3—third sorbent bed
14.4—fourth sorbent bed
15—sorbent
16—line from which hydrogen produced is withdrawn from the hydrogen pressure swing adsorption unit
18 line by which the water gas shift effluent is injected into the first sorbent bed along with sorbent
19.1 first phase separator
19.2 second phase separator
19.3 third phase separator
20 sorbent source
21 line by which the mixture of carbon dioxide depleted stream and sorbent exits the first sorbent bed
22 Line by which the sorbent from separator 19.1 is introduced into the second sorbent bed
23 thermo-compressor
24 line by which the purge effluent gas is recycled to the gasification unit line by which steam is injected into thee thermo-compressor 23
26 line by which the purged sorbent is passed to the third sorbent bed
27 first heat exchanger
28 line for recycling carbon dioxide to the third sorbent bed
29 third heat exchanger
30 indirect heat exchanger
31 line by which the mixture of sorbent and the carbon dioxide gas steam is passed along to the second phase separator
32 line by which the sorbent is passed to the fourth sorbent bed
33 second heat exchanger
34 line by which mixture of steam and/or any other moisture containing stream and the rehydroxylated sorbent is withdrawn from the fourth sorbent bed and sent to the third phase separator
35 line by which rehydroxylated sorbent is recycled back to line 18
36 line by which remaining steam and/or other moisture containing stream is withdrawn and sent to be either condensed or used elsewhere
37 line for withdrawing carbon dioxide as product
39 thermo-compressor
40 line to supply steam to the thermo-compressor 39
41 line for supplying steam and/or any other moisture containing stream to the fourth sorbent bed

1: A process for recovering hydrogen and high temperature and high pressure carbon dioxide from one or more hydrocarbon feed streams, said process comprising:
a) introducing the one or more hydrocarbon feed streams into a high pressure gasification unit to produce a sour syngas stream that contains at least hydrogen, carbon monoxide, carbon dioxide, sulfur containing compounds, methane and water vapor;
b) subjecting the sour syngas stream to desulfurization in a sulfur removal unit to obtain an essentially sulfur free syngas stream;
c) subjecting the essentially sulfur free syngas stream to water gas shift in a water gas shift reactor to obtain a water gas shift effluent;
d) subjecting the water gas shift effluent to treatment in a carbon dioxide removal unit that contains at least a first sorbent bed, a second sorbent bed, and a third sorbent bed and a fourth sorbent bed, the first, second, third and fourth sorbent beds being connected in series and being configured to allow for the passage of a gas and a magnesium based sorbent that is highly selective for carbon dioxide through the series of sorbent beds, the treatment involving:
i) a sorption phase in which the water gas shift effluent and the magnesium based sorbent are introduced into the first sorbent bed at a temperature from about 100° C. to about 315° C. and a pressure from about 10 to about 40 bar, the carbon dioxide in the water gas shift effluent selectively reacting with the sorbent and a portion of the remaining components of the water gas shift effluent nonspecifically reacting with the sorbent to produce a mixture comprising reacted sorbent and a carbon dioxide depleted stream as the water gas shift effluent and sorbent pass through the first sorbent bed,
ii) a first separation in which the mixture comprising reacted sorbent and the carbon dioxide depleted stream pass from the first sorbent bed and through a first phase separator to separate the reacted sorbent from the carbon dioxide depleted stream,
iii) a purge phase in which the reacted sorbent and a high pressure superheated steam are each introduced into a the second sorbent bed in order to purge the reacted sorbent of the nonspecifically trapped components from the water gas shift effluent thereby producing a mixture of purged sorbent which is withdrawn from a bottom of the second sorbent bed and a purge effluent gas which is withdrawn from a top of the second sorbent bed;
iv) a carbon dioxide release phase in which the purged sorbent is introduced into the third sorbent bed along with superheated steam, the high pressure superheated steam used along with indirect heat to raise the temperature of the third sorbent bed to of between 350° C. and 420° C. thereby allowing for the release of the carbon dioxide from the purged sorbent to produce a carbon dioxide deficient sorbent and a wet, high temperature carbon dioxide rich stream;
v) a second separation in which the carbon dioxide deficient sorbent and the carbon dioxide rich stream are passed from the third sorbent bed and through a second phase separator to separate the carbon dioxide deficient sorbent and a carbon dioxide product stream;
vi) a rehydroxylation phase in which the carbon dioxide deficient sorbent is introduced into a the fourth sorbent bed where the temperature is lowered to about 200° C. to 300° C. and the carbon dioxide deficient sorbent is contacted with steam and/or a moisture containing stream to allow for the rehydroxylation of the sorbent,
vii) a third separation in which the rehydroxylated sorbent and the steam and/or a moisture containing stream are passed from the fourth sorbent bed and through a third phase separator to separate the steam and/or a moisture containing stream from the rehydroxylated sorbent;
e) recycling the rehydroxylated sorbent to the first sorbent bed;
f) recycling the purge effluent gas along with the high pressure superheated steam to the essentially sulfur free syngas stream that is to be introduced into the water gas shift reactor unit;
g) passing the wet high temperature carbon dioxide rich stream on for further use; and
h) introducing the carbon dioxide depleted stream obtained into a pressure swing adsorption unit to allow for the recovery of a high purity gaseous hydrogen stream.

2: The process of claim 1, wherein the gasification unit is a coal gasification unit.

3: The process of claim 1, wherein the sorbent is passed through a heat exchanger prior to being introduced into the third sorbent bed in order to raise the temperature of the sorbent.

4: The process of claim 1, wherein the sorbent is passed through a heat exchanger prior to being introduced into the fourth sorbent bed in order to lower the temperature of the sorbent.

5: The process of claim 1, wherein a portion of the hot carbon dioxide product stream is used to further fluidize the sorbent in the third sorbent bed.

6: The process of claim 1, wherein the carbon dioxide removal unit contains more than one sorbent bed corresponding to each phase of the carbon dioxide removal.

7: The process of claim 1, wherein the magnesium based sorbent used in the sorbent beds is magnesium hydroxide.

8: The process of claim 7, wherein the pressure in all sorbent beds is relatively the same.

9: The process of claim 1, wherein each of the sorbent beds includes a means for heating and cooling the sorbent bed.

10: The process of claim 9, wherein the means for heating and cooling the sorbent beds includes a series of heat transfer surfaces that run through the sorbent beds, the heat transfer surfaces having disposed therein a heated transfer media which becomes heated due to the heat generated with sorption and rehydroxylation.

11: The process of claim 10, wherein the heated transfer media is used to generate high pressure steam for the carbon dioxide removal unit or the high pressure gasification unit or as a source of heat for the process for recovering hydrogen and high temperature and high pressure carbon dioxide from one or more hydrocarbon feed streams.

12: The process of claim 11, wherein the heated transfer media which has recovered the heat from the process streams of the high pressure gasification unit and/or water gas shift reactor is used to heat the sorbent.

13: The process of claim 11, wherein the heated transfer media which has recovered the heat to cool the sorbent is used to heat the process streams of the high pressure gasification unit.

14: The process of claim 11, wherein the heated transfer media is molten carbonate salt mixture.

15: The process of claim 11, wherein the heated transfer media is an inorganic or organic compound with a boiling point that ranges about 250° C. to about 350° C.

16-17. (canceled)

18: A process for recovering hydrogen and high temperature and high pressure carbon dioxide from one or more hydrocarbon feed streams, said process comprising:
a) introducing the one or more hydrocarbon feed streams into a high pressure gasification unit to produce a syngas stream that contains at least hydrogen, carbon monoxide, carbon dioxide, methane and water vapor;
b) subjecting the syngas stream to water gas shift in a water gas shift reactor to obtain a water gas shift effluent;
c) subjecting the water gas shift effluent to treatment in a carbon dioxide removal unit that contains at least a first sorbent bed, a second sorbent bed, and a third sorbent bed and a fourth sorbent bed, the first, second, third and fourth sorbent beds being connected in series and being configured to allow for the passage of a gas and a magnesium based sorbent that is highly selective for carbon dioxide through the series of sorbent beds, the treatment involving:
i) a sorption phase in which the water gas shift effluent and the magnesium based sorbent are introduced into the first sorbent bed at a temperature from about 100° C. to about 315° C. and a pressure from about 10 to about 40 bar, the carbon dioxide in the water gas shift effluent selectively reacting with the sorbent and a portion of the remaining components of the water gas shift effluent nonspecifically reacting with the sorbent to produce a mixture comprising reacted sorbent and a carbon dioxide depleted stream as the water gas shift effluent and sorbent pass through the first sorbent bed,
ii) a first separation in which the mixture comprising reacted sorbent and the carbon dioxide depleted stream pass from the first sorbent bed and through a first phase separator to separate the reacted sorbent from the carbon dioxide depleted stream,
iii) a purge phase in which the reacted sorbent and a high pressure superheated steam are each introduced into a the second sorbent bed in order to purge the reacted sorbent of the nonspecifically trapped components from the water gas shift effluent thereby producing a mixture of purged sorbent which is withdrawn from a bottom of the second sorbent bed and a purge effluent gas which is withdrawn from a top of the second sorbent bed;
iv) a carbon dioxide release phase in which the purged sorbent is introduced into a the third sorbent bed along with superheated steam, the high pressure superheated steam used along with indirect heat to raise the temperature of the third sorbent bed to of between 350° C. and 420° C. thereby allowing for the release of the carbon dioxide from the purged sorbent to produce a carbon dioxide deficient sorbent and a wet, high temperature carbon dioxide rich stream;
v) a second separation in which the carbon dioxide deficient sorbent and the carbon dioxide rich stream are passed from the third sorbent bed and through a second phase separator to separate the carbon dioxide deficient sorbent and a carbon dioxide product stream;
vi) a rehydroxylation phase in which the carbon dioxide deficient sorbent is introduced into the fourth sorbent bed where the temperature is lowered to about 200° C. to 300° C. and the carbon dioxide deficient sorbent is contacted with steam and/or a moisture containing stream to allow for the rehydroxylation of the sorbent,
vii) a third separation in which the rehydroxylated sorbent and the steam and/or a moisture containing stream are passed from the fourth sorbent bed and through a third phase separator to separate the steam and/or a moisture containing stream from the rehydroxylated sorbent;
d) recycling the rehydroxylated sorbent to the first sorbent bed;
e) recycling the purge effluent gas along with the high pressure superheated steam to the water gas shift reactor;
f) passing the wet, high temperature carbon dioxide rich stream on for further use; and
g) introducing the carbon dioxide depleted stream obtained into a pressure swing adsorption unit to allow for the recovery of a high purity gaseous hydrogen stream.

19: The process of claim 18, wherein the gasification unit is a coal gasification unit.

20: The process of claim 18, wherein the sorbent is passed through a heat exchanger prior to being introduced into the third sorbent bed in order to raise the temperature of the sorbent.

21: The process of claim 18, wherein the sorbent is passed through a heat exchanger prior to being introduced into the fourth sorbent bed in order to lower the temperature of the sorbent.

22: The process of claim 18, wherein a portion of the hot carbon dioxide product stream is used to further fluidize the sorbent in the third sorbent bed.

23: The process of claim 18, wherein the carbon dioxide removal unit contains more than one sorbent bed corresponding to each phase of the carbon dioxide removal.

24: The process of claim 18, wherein the magnesium based sorbent used in the sorbent beds is magnesium hydroxide.

25: The process of claim 24, wherein the pressure in all sorbent beds is relatively the same.

26: The process of claim 18, wherein each of the sorbent beds includes a means for heating and cooling the sorbent bed.

27: The process of claim 26, wherein the means for heating and cooling the sorbent beds includes a series of heat transfer surfaces that run through the sorbent beds, the heat transfer surfaces having disposed therein a heated transfer media which becomes heated due to the heat generated with sorption and rehydroxylation.

28-33. (canceled)

34: The process of claim 18, wherein prior to a portion of the wet high temperature carbon dioxide rich stream being recycled to the stream to be introduced into the water gas shift reactor, the carbon dioxide rich stream is passed through a thermo-compressor while high pressure steam is introduced.
